(19) United States
(12) Patent Application Publication
(10) Pub. No.: US 2024/0378769 A1
(43) Pub. Date: Nov. 14, 2024

(54) EFFECT PROCESSING METHOD AND APPARATUS, ELECTRONIC DEVICE AND STORAGE MEDIUM

(71) Applicant: BEIJING ZITIAO NETWORK TECHNOLOGY CO., LTD., Beijing (CN)

(72) Inventors: Jiaxin MA, Beijing (CN); Shuaijie YANG, Beijing (CN)

(21) Appl. No.: 18/662,502

(22) Filed: May 13, 2024

(30) Foreign Application Priority Data
May 12, 2023 (CN) 202310540514.5

(51) Int. Cl. G06T 11/00; G06T 7/11; G06T 7/12; G06T 7/90

(52) U.S. Cl. CPC G06T 11/001; G06T 7/11; G06T 7/12; G06T 7/90; G06T 2207/10024; G06T 2207/10028; G06T 2210/24

(57) ABSTRACT

Disclosed in the present disclosure are an effect processing method and apparatus, an electronic device and a storage medium. The method includes: obtaining, in response to an effect trigger operation, a liquid effect object and a to-be-processed scene image corresponding to the effect trigger operation; generating an effect scene image based on the liquid effect object and the to-be-processed scene image, and displaying the effect scene image; and adjusting, if a preset liquid level adjustment condition is detected to be achieved, a display liquid level of the liquid effect object, and updating the effect scene image based on the adjusted display liquid level.

### CROSS-REFERENCE TO RELATED APPLICATION

The present application claims the priority of Chinese patent application No. 202310540514.5 filed on May 12, 2023, and the entire content disclosed by the Chinese patent application is incorporated herein by reference as part of the present application.

### TECHNICAL FIELD

Embodiments of the present disclosure relate to the field of image processing technology, and in particular to an effect processing method and apparatus, an electronic device and a storage medium.

### BACKGROUND

In the processing mode of enriching the display effect of images or videos, the method of adding effects to images or videos by using effect props is widely used. With the development of effects production technology, the types of effect props are becoming more and more abundant. Among them, there are many liquid effect props that show liquid effect objects.

### SUMMARY

At least one embodiment of the present disclosure provides an effect processing method, comprising: obtaining, in response to an effect trigger operation, a liquid effect object and a to-be-processed scene image corresponding to the effect trigger operation; generating an effect scene image based on the liquid effect object and the to-be-processed scene image, and displaying the effect scene image; and adjusting, if a preset liquid level adjustment condition is detected to be achieved, a display liquid level of the liquid effect object, and updating the effect scene image based on the adjusted display liquid level.

For example, in the effect processing method provided by at least one embodiment of the present disclosure, the liquid level adjustment condition comprises at least one of the following conditions: receiving a control trigger operation that acts on a preset display liquid level adjustment control; receiving a liquid level adjustment trigger operation that acts on the liquid effect object displayed in the effect scene image; receiving a terminal posture adjustment operation of an effect processing terminal corresponding to the effect trigger operation; detecting that a liquid level adjustment time of the display liquid level corresponding to the liquid effect object is reached; detecting an audio control instruction and/or a gesture control instruction for adjusting the display liquid level corresponding to the liquid effect object.

For example, in the effect processing method provided by at least one embodiment of the present disclosure, after adjusting the display liquid level of the liquid effect object, the method further comprises: adjusting display color information of the liquid effect object based on the display liquid level.

For example, in the effect processing method provided by at least one embodiment of the present disclosure, after adjusting the display liquid level of the liquid effect object, the method further comprises: switching, if the display liquid level reaches a preset status switching height threshold, a relative display status between the to-be-processed scene image and the liquid effect object, wherein the relative display status at least comprises a first display state in which at least part of the to-be-processed scene image is displayed above a liquid surface of the liquid effect object and a second display state in which at least part of the to-be-processed scene image is displayed below the liquid surface of the liquid effect object.

For example, in the effect processing method provided by at least one embodiment of the present disclosure, the generating an effect scene image based on the liquid effect object and the to-be-processed scene image comprises: determining, based on the display liquid level of the liquid effect object, an object effect rendering region corresponding to the liquid effect object and a scene display region corresponding to the to-be-processed scene image, wherein the object effect rendering region comprises a first rendering region below a liquid surface of the liquid effect object and/or a second rendering region corresponding to the liquid surface; determining an object region effect based on the object effect rendering region, and generating the effect scene image based on the object region effect and the scene display region.

For example, in the effect processing method provided by at least one embodiment of the present disclosure, the determining an object region effect based on the object effect rendering region comprises: determining, if the object effect rendering region comprises the first rendering region, caustics color information and basic color information corresponding to the liquid effect object; determining an object region effect corresponding to the first rendering region of the liquid effect object based on the basic color information and the caustics color information.

For example, in the effect processing method provided by at least one embodiment of the present disclosure, the determining caustics color information corresponding to the liquid effect object comprises: determining first caustics sampling coordinates and second caustics sampling coordinates; sampling a preset caustics map based on the first caustics sampling coordinates and the second caustics sampling coordinates, respectively, so as to obtain a first sampling caustics value and a second sampling caustics value; determining the caustics color information corresponding to the liquid effect object based on the first sampling caustics value and the second sampling caustics value.

For example, in the effect processing method provided by at least one embodiment of the present disclosure, the determining first caustics sampling coordinates and second caustics sampling coordinates comprises: obtaining, for each to-be-rendered pixel point in the first rendering region, first reference sampling coordinates and second reference sampling coordinates, and determining sampling disturbance information corresponding to the first reference sampling coordinates and the second reference sampling coordinates, respectively; determining the first caustics sampling coordinates and the second caustics sampling coordinates, respectively, based on the first reference sampling coordinates, the second reference sampling coordinates and the sampling disturbance information.

For example, in the effect processing method provided by at least one embodiment of the present disclosure, the determining an object region effect corresponding to the first rendering region of the liquid effect object based on the basic color information and the caustics color information comprises: obtaining a scene depth image corresponding to the to-be-processed scene image, and mixing the basic color information and the caustics color information based on the scene depth image, so as to obtain the object region effect corresponding to the first rendering region of the liquid effect object.

For example, in the effect processing method provided by at least one embodiment of the present disclosure, the obtaining a scene depth image corresponding to the to-be-processed scene image comprises: acquiring the scene depth image corresponding to the to-be-processed scene image based on a depth image acquisition device arranged in a shooting terminal for capturing the to-be-processed scene image; or generating the scene depth image corresponding to the to-be-processed scene image based on the to-be-processed scene image.

For example, in the effect processing method provided by at least one embodiment of the present disclosure, the generating the scene depth image corresponding to the to-be-processed scene image based on the to-be-processed scene image comprises: performing a depth comparison on scene subjects contained in the to-be-processed scene image, and generating a binary depth map based on a comparison result; converting the binary depth map into a grayscale depth map based on a preset nonlinear conversion algorithm, and determining the scene depth image corresponding to the to-be-processed scene image based on the grayscale depth map, wherein a depth value corresponding to each pixel point in the scene depth image is within a preset value interval.

For example, in the effect processing method provided by at least one embodiment of the present disclosure, the determining an object region effect based on the object effect rendering region comprises: determining, if the object effect rendering region comprises the first rendering region and the second rendering region, a regional boundary between the first rendering region and the second rendering region, and determining a transitional rendering region in the second rendering region based on the regional boundary, wherein the first rendering region corresponds to the scene display region; determining, for each to-be-rendered pixel point in the transitional rendering region, a reference pixel point corresponding to the to-be-rendered pixel point based on the regional boundary, and determining target color information corresponding to the to-be-rendered pixel point based on a first depth value corresponding to the to-be-rendered pixel point and a second depth value corresponding to the reference pixel point; obtaining an object region effect of the transitional rendering region based on the target color information corresponding to each to-be-rendered pixel point in the transitional rendering region.

At least one embodiment of the present disclosure further provides an effect processing apparatus, comprising: an effect trigger module, configured to obtain, in response to an effect trigger operation, a liquid effect object and a to-be-processed scene image corresponding to the effect trigger operation; an effect display module, configured to generate an effect scene image based on the liquid effect object and the to-be-processed scene image, and to display the effect scene image; a display adjusting module, configured to adjust, if a preset liquid level adjustment condition is detected to be achieved, a display liquid level of the liquid effect object, and update the effect scene image based on the adjusted display liquid level.

At least one embodiment of the present disclosure further provides an electronic device, comprising: one or a plurality of processors; a storage apparatus, configured to store one or a plurality of programs, and the one or the plurality of programs, when executed by the one or the plurality of processors, cause the one or more the plurality of processors to realize an effect processing method, which comprises: obtaining, in response to an effect trigger operation, a liquid effect object and a to-be-processed scene image corresponding to the effect trigger operation; generating an effect scene image based on the liquid effect object and the to-be-processed scene image, and displaying the effect scene image; and adjusting, if a preset liquid level adjustment condition is detected to be achieved, a display liquid level of the liquid effect object, and updating the effect scene image based on the adjusted display liquid level.

At least one embodiment of the present disclosure further provides a storage medium comprising computer-executable instructions, wherein the computer-executable instructions, when executed by a computer processor, are used for executing the effect processing method provided by any embodiment of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of an effect processing method provided by an embodiment of the present disclosure;

FIG. 2A is a flowchart of another effect processing method provided by an embodiment of the present disclosure;

FIG. 2B is a schematic diagram of the effect of generating an effect scene image based on the effect processing method provided by an embodiment of the present disclosure;

FIG. 2C is another schematic diagram of the effect of generating an effect scene image based on the effect processing method provided by an embodiment of the present disclosure;

FIG. 3 is a flowchart of further another effect processing method provided by an embodiment of the present disclosure;

FIG. 4 is a flowchart of still another effect processing method provided by an embodiment of the present disclosure;

FIG. 5 is a schematic structural diagram of an effect processing apparatus provided by an embodiment of the present disclosure; and

FIG. 6 is a schematic structural diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the embodiments of the present disclosure are used for illustrative purposes only, and are not used to limit the scope of these messages or information.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Accordingly, the user can independently choose, according to the prompt information, whether to provide personal information to software or hardware, such as an electronic device, an application program, a server, or a storage medium, etc., for executing operations of the technical solution of the present disclosure.

In an alternative but non-limiting implementation, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device.

It is to be understood that the preceding process of notifying the user and obtaining authorization from the user is illustrative and does not limit the embodiments of the present disclosure, and that other manners complying with relevant laws and regulations may also be applied to the embodiments of the present disclosure.

It is to be understood that data (including, but not limited to, the data itself and acquisition or use of the data) involved in the technical solution should comply with corresponding laws and regulations and relevant provisions.

Regarding a liquid effect prop, a liquid effect object is statically displayed in a fixed form in the image to which the effect prop is applied. In some scenes, the liquid effect object can be dynamically displayed according to a preset motion mode. However, the relative display mode between the liquid effect object and the image to which the effect prop is applied is relatively fixed, and there is a lack of interaction with the user, so that the display effect of the generated effect image is relatively simple and the user's experience is affected.

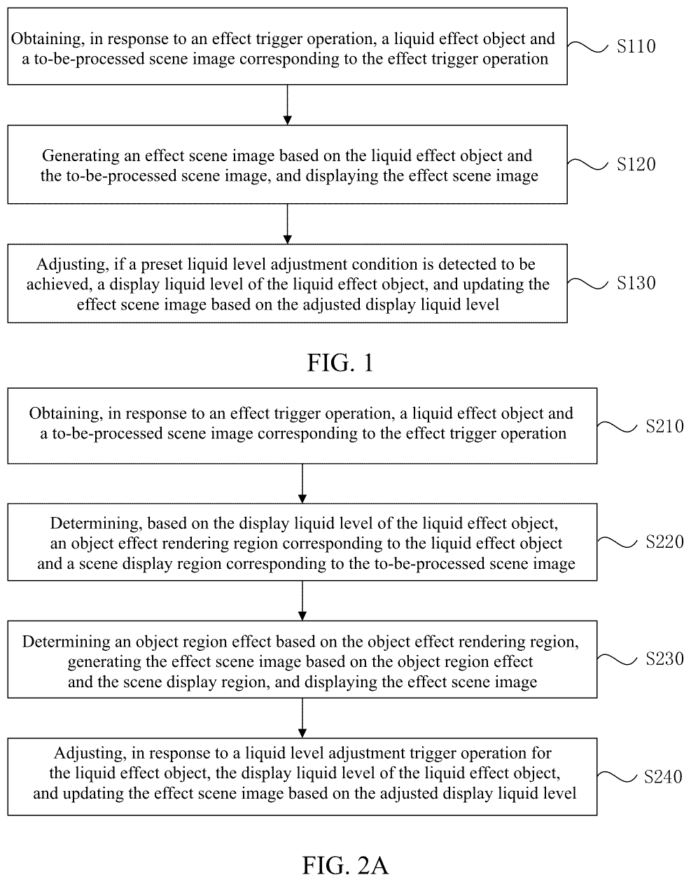

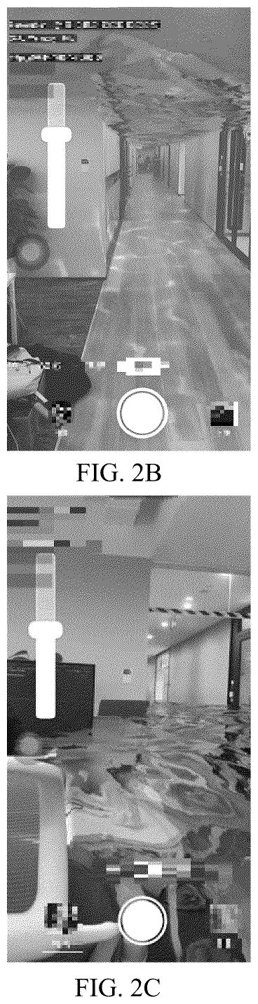

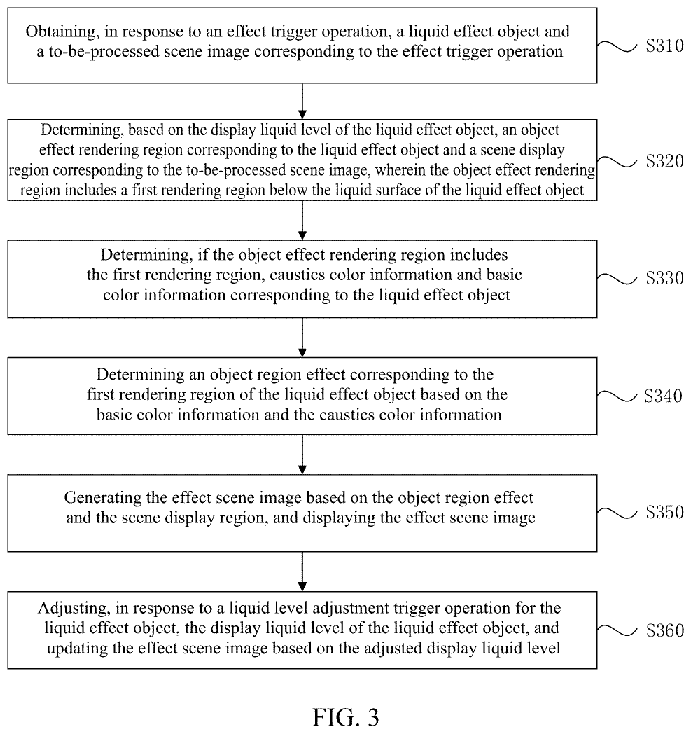

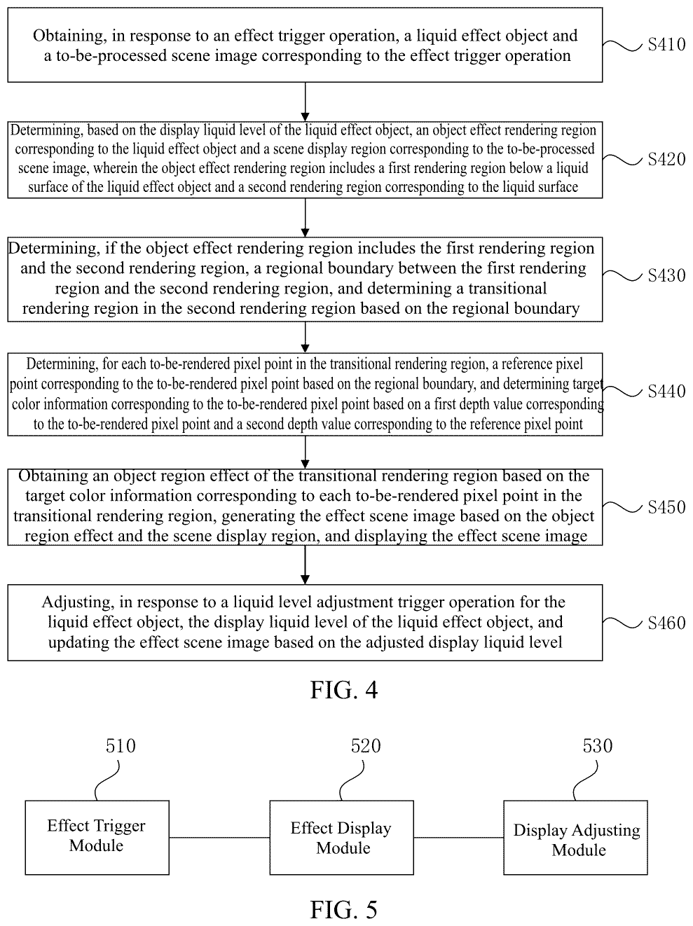

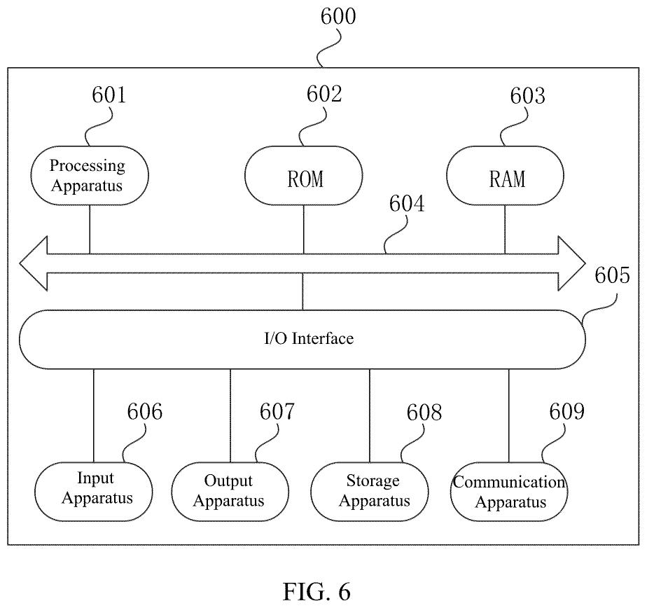

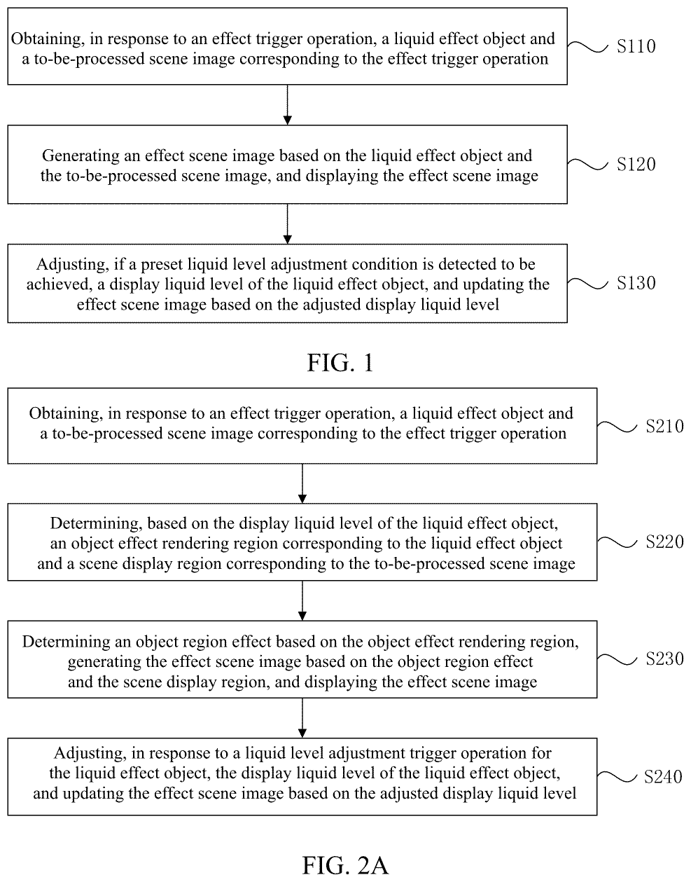

FIG. 1 is a flowchart of an effect processing method provided by an embodiment of the present disclosure. The embodiment of the present disclosure is applicable to the case of applying a liquid effect object to a to-be-processed scene image. The method can be executed by an effect processing apparatus, and the apparatus can be implemented in the form of software and/or hardware. The apparatus for executing the effect processing method provided by the embodiment of the present disclosure can be integrated in application software supporting the effect processing function, and the software can be installed in an electronic device. Optionally, the electronic device can be a mobile terminal or a PC terminal, etc. The application software can be software with the function of performing effect processing on images, or a kind of software that supports adding effects to images based on effect tools, such as short video software, effect tool software or image processing software, etc. The specific application software will not be elaborated, as long as effect processing can be realized. It can also be a specially developed application program, and can be integrated into the software for implementing effect processing, or integrated into a corresponding page. And the user can achieve effect processing through the page integrated on the PC terminal.

As illustrated in FIG. 1, the method of the present embodiment can specifically include:

S110: Obtaining, in response to an effect trigger operation, a liquid effect object and a to-be-processed scene image corresponding to the effect trigger operation.

The effect trigger operation can be understood as the operation used to enable a target effect after triggering. In the embodiment of the present disclosure, the target effect is associated with a liquid effect object. The liquid effect object can be understood as an effect objects presented in liquid form, such as water, magma or debris flow, etc. The to-be-processed scene image can be understood as a scene image to be processed with effects.

In the embodiment of the present disclosure, there can be many ways to generate the effect trigger operation. Illustratively, the effect trigger operation can include: a control trigger operation that acts on a preset effect trigger control; or a subject trigger operation detecting that the to-be-processed scene image includes a preset type of scene subject; or a time trigger operation detecting that a preset effect trigger time is reached; or a instruction trigger operation detecting a voice trigger instruction or gesture trigger instruction preset to enable the target effect, etc.

The effect trigger control can be a physical key configured on an effect processing terminal, such as a volume adjustment key, etc.; and it can also be a virtual control set on the display interface that can be operated by touch. The scene subject can be understood as the objects contained in the to-be-processed scene and used for constructing the scene, such as persons, buildings, animals, plants and rocks, etc.

Optionally, obtaining the to-be-processed scene image corresponding to the effect trigger operation includes: receiving a to-be-processed scene image uploaded based on a preset image upload control; or, obtaining an image captured by a shooting apparatus of an effect processing terminal as a to-be-processed scene image; or, obtaining a to-be-processed scene image corresponding to the effect triggering operation from a preset image database or a third-party platform, etc.

In the embodiment of the present disclosure, there may be one or more liquid effect objects, and the obtaining methods thereof may also be one or more. Optionally, in the case where there is only one liquid effect object, this liquid effect object is obtained as the liquid effect object corresponding to the effect trigger operation. In the case where there are a plurality of liquid effect objects, a default liquid effect object can be obtained from the preset plurality of liquid effect objects as the liquid effect object corresponding to the effect trigger operation, or one liquid effect object can be randomly obtained from the preset plurality of liquid effect objects, or one liquid effect object can be selected from the preset plurality of liquid effect objects as the liquid effect object corresponding to the effect trigger operation, and so on. For example, in particular, one or more candidate liquid effect objects can be displayed in response to the effect trigger operation. Further, in response to an object selection operation for the liquid effect objects, the selected liquid effect object is taken as the liquid effect object corresponding to the effect trigger operation.

S120: Generating an effect scene image based on the liquid effect object and the to-be-processed scene image, and displaying the effect scene image.

The effect scene image is an effect image obtained by applying the liquid effect object to the to-be-processed scene image.

In order to simulate the effect of liquid acting on the scene in a real scenario, in the embodiment of the present disclosure, a liquid level variation attribute is set for the liquid effect object. The effect scene image can vary according to the variation of the display liquid level of the liquid effect object. Specifically, after obtaining the liquid effect object and the to-be-processed scene image corresponding to the effect trigger operation, the display liquid level of the liquid effect object relative to the to-be-processed scene image can be determined first, and then, the effect scene image in which the liquid effect object is applied to the to-be-processed scene image can be generated based on the display liquid level of the liquid effect object. In other words, in the embodiment of the present disclosure, the method of generating the effect scene image can be determined according to the display liquid level of the liquid effect object.

At different display liquid levels, the relative display status between the to-be-processed scene image and the liquid effect object in the effect scene image can be the same or different. The relative display status can at least include a first display state in which at least part of the to-be-processed scene image is displayed above the liquid level of the liquid effect object and a second display state in which at least part of the to-be-processed scene image is displayed below the liquid level of the liquid effect object. Optionally, the relative display status further includes a third display state in which at least part of the to-be-processed scene image is displayed in the liquid surface region of the liquid effect object. In the embodiment of the present disclosure, different relative display statuses can correspond to different effect processing modes.

By adopting the technical solution, different effect scene images can be presented in the same effect trigger scene by associating the display liquid level of the liquid effect object with the processing modes of the effect scene images, so that the display effect of the effect scene image is enriched and the fine processing of the effect scene image is realized.

S130: Adjusting, if a preset liquid level adjustment condition is detected to be achieved, a display liquid level of the liquid effect object, and updating the effect scene image based on the adjusted display liquid level.

The liquid level adjustment condition can be understood as a condition used for adjusting the display liquid level of the liquid effect object in the effect scene image. The display liquid level can be understood as the liquid level information of the liquid effect object displayed in the effect scene image.

Optionally, the preset liquid level adjustment condition includes at least one of the following operations:
receiving a control trigger operation that acts on a preset liquid level adjustment control;
receiving a liquid level adjustment trigger operation that acts on the liquid effect object displayed in the effect scene image;
receiving a terminal posture adjustment operation of an effect processing terminal corresponding to the effect trigger operation;
detecting that a liquid level adjustment time of the display liquid level corresponding to the liquid effect object is reached;
detecting an audio control instruction and/or a gesture control instruction for adjusting the display liquid level corresponding to the liquid effect object.

The liquid level adjustment control can be an interface virtual control displayed relative to the effect scene image, and can also be a physical key set on the effect processing terminal corresponding to the effect trigger operation, such as a volume adjustment key or an orientation adjustment key, etc. Typically, in the case where the liquid level adjustment control is an interface virtual control, the liquid level adjustment control can be displayed in the edge region of the effect scene image. Illustratively, the liquid level adjustment control can at least be a slide adjustment control, a click control or a press control, etc., according to its trigger mode. Specifically, the control trigger operation that acts on the preset liquid level adjustment control can be a slide operation of the sliding position of a liquid level adjustment slider displayed relative to the effect scene image; it can be a click operation of clicking a liquid level switching control for switching the relative display status between the liquid effect object and the to-be-processed scene image, or a click operation of clicking a liquid level height adjustment control corresponding to the height value of the liquid level (e.g., a control for raising or lowering the liquid level according to a preset step size or a control for inputting the height value or height ratio of the liquid level, etc.); it can also be a press operation of pressing a liquid level adjustment control for adjusting the display liquid level of the liquid effect object. In the case where the liquid level adjustment control is a press control, the adjustment value of the display liquid level of the liquid effect object can be determined based on the duration of continuous pressing acting on the push control. Through the technical solution, the display liquid level of the liquid effect object is adjusted, the operation mode is simple, and the adjustment intention of the user on the display liquid level of the liquid effect object can be accurately and effectively captured, and the interactive experience of effect processing is improved.

Specifically, the effect processing terminal is a terminal that performs effect processing on the to-be-processed scene image. The terminal posture adjustment operation can be an operation of adjusting the terminal posture of the effect processing terminal. The terminal posture at least includes the terminal rotation angle. In the embodiment of the present disclosure, the display liquid level of the liquid effect object can be associated with the line of sight (which can be determined based on the camera parameters of the effect processing terminal) for observing the effect processing image. The technical solution is particularly suitable for the case where the to-be-processed scene image is an image captured based on the effect processing terminal; by adjusting the liquid effect object through the terminal posture adjustment operation of the effect processing terminal, the display effect of matching the effect processing scene with the line-of-sight variation is realized, and the linkage between the to-be-processed scene image and the liquid effect object is established, so that the display effect of the effect scene image is more vivid.

The liquid level adjustment time can be an adjustment time point or an adjustment time interval. The adjustment time point can be a preset fixed time point value or a dynamic time point read in real time. Taking that the liquid effect object is seawater as an example, the adjustment time point can be the actual tide rising time point and/or the actual tide falling time point of the seawater being read. The starting time point of the adjustment time interval can start from receiving the effect trigger operation, or from displaying the effect scene image, or from receiving a preset timing trigger operation, and so on. In the embodiment of the present disclosure, the specific value of the liquid level adjustment time is not specifically limited.

Specifically, after adjusting the display liquid level of the liquid effect object, an effect scene image in which the liquid effect object is applied to the to-be-processed scene image is regenerated based on the adjusted display liquid level, and the regenerated effect scene image is displayed, so that the updated effect scene image matches the display liquid level of the liquid effect object, and the effects of the liquid effect object acting on the to-be-processed scene image are enriched.

As an optional technical solution of the embodiment of the present disclosure, after adjusting the display liquid level of the liquid effect object, the method can further include adjusting display color information of the liquid effect object based on the display liquid level. The display color information of the liquid effect object can be understood as the color information displayed for the liquid effect object in the effect scene image. Specifically, an adjustment mode between the display liquid level and the display color information of the liquid effect object is set in advance, and then the display color information of the liquid effect object is adjusted based on the display liquid level and the adjustment mode. The adjustment mode can be the correspondence relationship between the color adjustment ratio of the display color information of the liquid effect object and the display liquid level, or the correspondence relationship between the display color information of the liquid effect object and the display liquid level. For example, the lower the liquid level of the liquid effect object, the lighter the display color of the liquid effect object. The higher the liquid level of the liquid effect object, the darker the display color of the liquid effect object. The advantage of this setting is that the display information of the liquid effect object can have stronger layering feeling and be more interesting, and in some scenarios, it can make the liquid effect object more in line with the real variation in physical scenarios, thus enhance the user's immersion.

As another optional technical solution of the embodiment of the present disclosure, after adjusting the display liquid level of the liquid effect object, the method can further include switching the relative display status of the to-be-processed scene image and the liquid effect object in the case where the display liquid level reaches a preset status switching height threshold. As described above, the relative display status is associated with the display liquid level, so the status switching height threshold corresponding to the relative display status can be set in advance; and then, in the case where the display liquid level of the liquid effect object reaches the status switching height threshold, the relative display status between the to-be-processed scene image and the liquid effect object can be switched to a relative display status corresponding thereto. As can be seen from the foregoing, there can be various relative display statuses. Each relative display status can correspond to a status switching height threshold. Furthermore, by adjusting the display level of the liquid effect object, the relative display status can be switched.

Optionally, in the case where the adjusted display liquid level is within a preset status switching critical range corresponding to the status switching height threshold, the height value corresponding to the display liquid level can be increased or decreased based on a preset height value, so that the adjusted height value corresponds to a relative display status different from the current relative display status, thereby realizing the switching of the relative display status.

The technical solution has the advantages that the relative display status between the liquid effect object and the to-be-processed scene image in the effect scene image can be simply and quickly switched, and the variation information thereof can be clearly displayed on the visual level, so that the processing result of the effect scene image is more intuitive.

According to the technical solution of the embodiment of the present disclosure, in response to an effect trigger operation, a liquid effect object and a to-be-processed scene image corresponding to the effect trigger operation are obtained, an effect scene image based on the liquid effect object and the to-be-processed scene image is generated, and the effect scene image is displayed, so that the user's effect processing intention can be accurately captured based on the effect trigger operation, and the effect image corresponding to the user's effect processing intention can be automatically generated and displayed, facilitating the user viewing the effect. Further, in response to a liquid level adjustment trigger operation for the liquid effect object, the display liquid level of the liquid effect object is adjusted, and the effect scene image is updated based on the adjusted display liquid level, so that the display mode of the effect scene image can be adjusted based on the user's interactive operation, the technical problems that the display effect of the effect image is relatively simple and lacks interaction with the user are solved; adjusting the display liquid level of the liquid effect object through interactive operation is supported, and the display liquid level is associated with the display effect of the effect scene image, thus enriching the effect of the liquid effect object and the to-be-processed scene image, realizing the flexible adjustment of the effect, increasing the interest of effect processing, and improving the effect processing experience of the user.

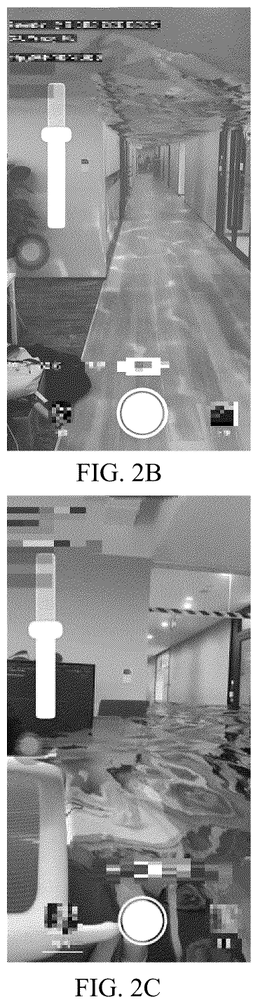

FIG. 2A is a flowchart of another effect processing method provided by an embodiment of the present disclosure. On the basis of the above embodiment, the technical solution of the present embodiment further refines how to generate an effect scene image according to the liquid effect object and the to-be-processed scene image. Optionally, firstly, an object effect rendering region corresponding to the liquid effect object and a scene display region corresponding to the to-be-processed scene image are determined based on the display liquid level of the liquid effect object; then, an object region effect is determined based on the object effect rendering region; and finally, the effect scene image is generated based on the object region effect and the scene display region. The specific implementation method can be found in the description of the present embodiment. The technical features that are the same or similar to the aforementioned embodiments will not be repeated here.

As shown in FIG. 2A, the method of the present embodiment can specifically include:

S210: Obtaining, in response to an effect trigger operation, a liquid effect object and a to-be-processed scene image corresponding to the effect trigger operation.

S220: Determining, based on the display liquid level of the liquid effect object, an object effect rendering region corresponding to the liquid effect object and a scene display region corresponding to the to-be-processed scene image.

The object effect rendering region can be understood as a region, which is to be rendered into the effect scene image at the current moment, in the liquid effect object. Optionally, the liquid effect object is divided into two or more object effect rendering regions according to the effect rendering effects of different regions of the liquid effect object in advance, and the correlation relationship between the display liquid level and the object effect rendering region is determined. Furthermore, the object effect rendering regions corresponding to the liquid effect object are determined based on the display liquid level of the liquid effect object, the number of which can be one or more. Specifically, the object effect rendering region can include a first rendering region below a liquid surface of the liquid effect object and/or a second rendering region corresponding to the liquid surface.

The scene display region can be understood as a region, which is rendered and displayed in the effect scene image, in the to-be-processed scene image. The scene display region can be a partial or complete region in the to-be-processed scene image.

Specifically, at the current display liquid level, the relative display status between the to-be-processed scene image and the liquid effect object, the object effect rendering region corresponding to the liquid effect object, and the scene display region corresponding to the to-be-processed scene image are determined.

Optionally, in the case where the relative display status is the first display state, it can be a display state in which the liquid effect object is used to block the regions of the to-be-processed scene image at the liquid surface and below the liquid surface. From the visual effect, the liquid effect object and the image information above the liquid surface of the liquid effect object in the to-be-processed scene image are displayed, and the image information of the to-be-processed scene image is not displayed in the region where the liquid effect object is displayed, as illustrated in FIG. 2B. In this case, optionally, the image display information of the image region of the to-be-processed scene image, which is displayed above the liquid surface of the liquid effect object, is the original image display information in the to-be-processed scene image, or the image display information after image processing (e.g., scaling processing, beauty processing, processing with a preset filter, or deformation processing) is performed on the to-be-processed scene image.

Optionally, in the case where the relative display status is the second display state, it can be a state in which the entire to-be-processed scene image is displayed below the liquid surface, that is, the liquid surface of the liquid effect object is displayed in the effect scene image, and the superposition effect of the to-be-processed scene image and the liquid effect object is displayed below the liquid surface, as illustrated in FIG. 2C. Optionally, the image display information of the to-be-processed scene image displayed below the liquid surface is the original image display information in the to-be-processed scene image, or the image display information after image processing (e.g., scaling processing, beauty processing, processing with a preset filter, or deformation processing) is performed on the to-be-processed scene image.

S230: Determining an object region effect based on the object effect rendering region, generating the effect scene image based on the object region effect and the scene display region, and displaying the effect scene image.

In the embodiment of the present disclosure, the object effect rendering region can be one or more. The object region effects corresponding to the object effect rendering regions can be the same or different.

Illustratively, the region rendering mode corresponding to each object effect rendering region can be set separately, and then, for each object effect rendering region, the object region effect corresponding thereto can be determined based on the region rendering mode corresponding to the object effect rendering region.

For example, in the case where the object effect rendering region is the first rendering region, the object region effect corresponding to the object effect rendering region can be determined based on the basic color information corresponding to the liquid effect object and the optical characteristic information corresponding to the first rendering region. The optical characteristic information includes at least one of caustics color information, reflective color information and refractive color information that the liquid effect object can present under the irradiation of a preset light source (e.g., parallel light). It should be noted that the optical characteristic information corresponding to the first rendering region can be set according to actual needs, and there is no restriction on which kind of optical characteristic information is adopted and how to obtain the optical characteristic information.

For another example, in the case where the object effect rendering region is the second rendering region, the second rendering region can be divided into a normal rendering region and a transitional rendering region. The object region effect of the normal rendering region can be determined based on a preset rendering effect thereof, which is only related to the effect display information setting of the liquid effect object itself. The transitional rendering region can be combined with other regions that are expected to be associated with, and is related to the display information of the normal rendering region and/or the scene display region, such as the depth information of the scene subject and/or the color information of the scene subject, etc., in the to-be-processed scene image in the scene display region.

By adopting the technical solution, not only the liquid effect object can be rendered in segmented regions and segmented effects, but also strong technical support can be provided for improving the adaptability and high fusion degree of the liquid effect object and the to-be-processed scene image.

Specifically, the generating the effect scene image based on the object region effect and the scene display region can be that: after the object region effect is determined, the scene display information corresponding to the scene display region is determined, and then the object region effect and the scene display information corresponding to the scene display region are superimposed to obtain the effect scene image.

S240: Adjusting, in response to a liquid level adjustment trigger operation for the liquid effect object, the display liquid level of the liquid effect object, and updating the effect scene image based on the adjusted display liquid level.

According to the technical solution of the embodiment of the present disclosure, the object effect rendering region corresponding to the liquid effect object can be determined through the display liquid level of the liquid effect object, the liquid effect object can be rendered in segmented regions; and the to-be-processed scene image can be separately processed through the display liquid level of the liquid effect object to determine the scene display region thereof; the fine processing of the effect scene image is realized by rendering the liquid effect object and the to-be-processed scene image respectively, so that the display effect of the effect scene image can have stronger layering feeling, the image details more abundant, and the display effect of the effect scene image is further improved.

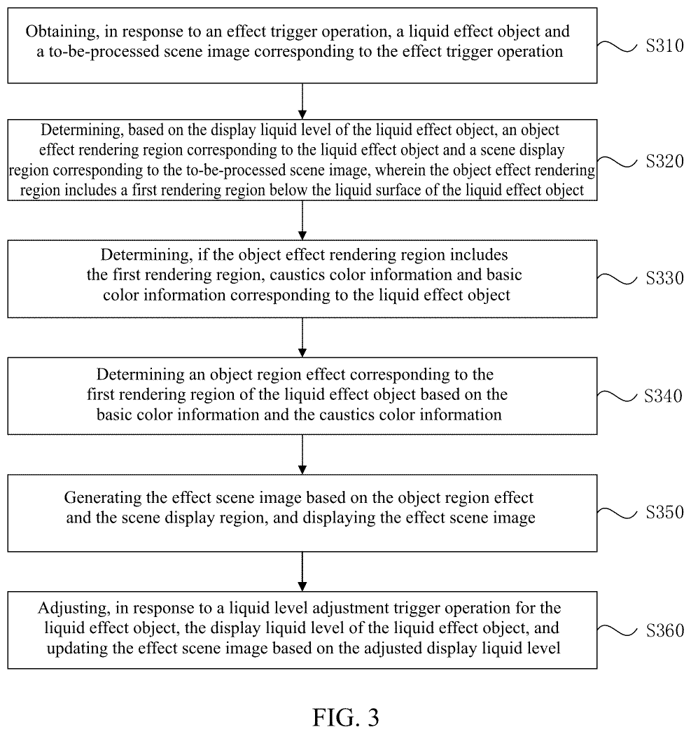

FIG. 3 is a flowchart of another effect processing method provided by an embodiment of the present disclosure. On the basis of the above embodiment, the technical solution of the present embodiment further refines how to render the effect of the region below the liquid surface of the liquid effect object. Optionally, in the case where the object effect rendering region includes the first rendering region, caustics color information and basic color information corresponding to the liquid effect object are determined; and an object region effect corresponding to the first rendering region of the liquid effect object is determined based on the basic color information and the caustics color information. The specific implementation method can be found in the description of the present embodiment. The technical features that are the same or similar to the aforementioned embodiments will not be repeated here.

As shown in FIG. 3, the method of the present embodiment can specifically include:

S310: Obtaining, in response to an effect trigger operation, a liquid effect object and a to-be-processed scene image corresponding to the effect trigger operation.

S320: Determining, based on the display liquid level of the liquid effect object, an object effect rendering region corresponding to the liquid effect object and a scene display region corresponding to the to-be-processed scene image, wherein the object effect rendering region includes a first rendering region below the liquid surface of the liquid effect object.

S330: Determining, if the object effect rendering region includes the first rendering region, caustics color information and basic color information corresponding to the liquid effect object.

The basic color information corresponding to the liquid effect object can be understood as the main color or reference color corresponding to the liquid effect object, which is used to determine the main color tone corresponding to the liquid effect object. The basic color information corresponding to each pixel point in the liquid effect object can be the same.

Illustratively, determining the basic color information corresponding to the liquid effect object can include: obtaining a preset basic color information corresponding to the liquid effect object; or, determining the basic color information corresponding to the liquid effect object according to a first included angle between the viewing angle and the normal of the liquid surface of the liquid effect object and a second included angle between the viewing angle and the orientation of parallel light. By using the preset basic color information, the basic color information corresponding to the liquid effect object can be read simply and quickly, and the consistency of the basic color information of the liquid effect object can be ensured. The basic color information, determined by using the viewing angle, the normal of the liquid surface of the liquid effect object and the orientation of the parallel light, can better simulate the real visual observation effect and help to provide immersive experience.

The caustics color information corresponding to the liquid effect object can be understood as the color information when the liquid effect object presents a caustics effect. In the present technical solution, by adding caustics color information to the liquid effect object, the display effect corresponding to the liquid effect object can be more vivid and realistic.

Optionally, the caustics color information corresponding to the liquid effect object is determined by sampling a preset caustics map. Specifically, first caustics sampling coordinates and second caustics sampling coordinates are determined; a preset caustics map is sampled based on the first caustics sampling coordinates and the second caustics sampling coordinates respectively; so as to obtain a first sampling caustics value and a second sampling caustics value; the caustics color information corresponding to the liquid effect object is determined based on the first sampling caustics value and the second sampling caustics value. Compared with obtaining the caustics color information corresponding to the liquid effect object by sampling the preset caustics map for once, the method of sampling for twice can smoothly and richly display the caustics effect of the liquid effect object.

On this basis, determining the first caustics sampling coordinates and the second caustics sampling coordinates can include: obtaining, based on a preset random algorithm, two sampling coordinates as the first caustics sampling coordinates and the second caustics sampling coordinates respectively.

In the embodiment of the present disclosure, determining the first caustics sampling coordinates and the second caustics sampling coordinates can further include: obtaining, for each to-be-rendered pixel point in the first rendering region, first reference sampling coordinates and second reference sampling coordinates, and determining sampling disturbance information corresponding to the first reference sampling coordinates and the second reference sampling coordinates, respectively; determining the first caustics sampling coordinates and the second caustics sampling coordinates, respectively, based on the first reference sampling coordinates, the second reference sampling coordinates and the sampling disturbance information. According to the present technical solution, when the preset caustics map is sampled, disturbance information is added to two sampling coordinates respectively, so that the flexibility of the caustics effect of the liquid effect object can be improved.

Optionally, determining sampling disturbance information corresponding to the first reference sampling coordinates and the second reference sampling coordinates, respectively, includes: determining a projection point of the to-be-rendered pixel point on the liquid surface of the liquid effect object; determining a normal corresponding to the projection point based on a preset normal map, and determining, based on the normal, the sampling disturbance information corresponding to the first reference sampling coordinates and the second reference sampling coordinates, respectively. The determining a normal corresponding to the projection point based on a preset normal map can specifically be taking the coordinates of the projection point as the coordinates of a sampling point in the preset normal map and acquiring the normal corresponding to the projection point.

As an optional technical solution of the embodiment of the present disclosure, determining, based on the normal, the sampling disturbance information corresponding to the first reference sampling coordinates and the second reference sampling coordinates, respectively, can include: for the first sampling reference coordinates or the second sampling reference coordinates, determining first disturbance information based on a preset normal adjustment coefficient and the normal, determining second disturbance information based on a preset motion speed and motion time, and determining the sampling disturbance information based on the first disturbance information and the second disturbance information. Illustratively, the first disturbance information and the second disturbance information can be added to obtain the sampling disturbance information. The first disturbance information can be obtained by multiplying the preset normal adjustment coefficient with the normal. The normal adjustment coefficient can be a user-defined value, and the value can be between 0 and 1. The motion speed can also be a user-defined value. The motion time can be determined based on the frame rate of obtaining the to-be-processed scene image, or can be the updating time of the effect scene image, and so on.

It should be noted that for different sampling reference coordinates, the motion information corresponding thereto can be the same or different, and accordingly, the sampling disturbance information corresponding thereto can be the same or different. After determining the sampling disturbance information, the first caustics sampling coordinates are determined based on the first reference sampling coordinates and the sampling disturbance information corresponding to the first reference sampling coordinates, and the second caustics sampling coordinates are determined based on the second reference sampling coordinates and the sampling disturbance information corresponding to the second reference sampling coordinates.

S340: Determining an object region effect corresponding to the first rendering region of the liquid effect object based on the basic color information and the caustics color information.

As an optional technical solution of the embodiment of the present disclosure, the basic color information and the caustics color information can be mixed by using preset weight values, so as to obtain the object region effect corresponding to the first rendering region of the liquid effect object.

In another optional technical solution of the embodiment of the present disclosure, a scene depth image corresponding to the to-be-processed scene image can be obtained, and the basic color information and the caustics color information can be mixed based on the scene depth image, so as to obtain the object region effect corresponding to the first rendering region of the liquid effect object.

The scene depth image can be understood as an image used to indicate a depth value corresponding to each pixel point in the to-be-processed scene image. Optionally, the obtaining a scene depth image corresponding to the to-be-processed scene image includes: acquiring the scene depth image corresponding to the to-be-processed scene image based on a depth image acquisition device arranged in a shooting terminal for capturing the to-be-processed scene image; or, generating the scene depth image corresponding to the to-be-processed scene image based on the to-be-processed scene image.

The shooting terminal can be a mobile terminal, such as a mobile phone, a tablet computer or a telephone watch, etc. The depth image acquisition device can be an augmented reality technology camera or a LiDAR camera configured on the shooting terminal.

Specifically, the generating the scene depth image corresponding to the to-be-processed scene image based on the to-be-processed scene image includes: performing a depth comparison on scene subjects contained in the to-be-processed scene image, and generating a binary depth map based on a comparison result; converting the binary depth map into a grayscale depth map based on a preset nonlinear conversion algorithm, and determining the scene depth image corresponding to the to-be-processed scene image based on the grayscale depth map, wherein a depth value corresponding to each pixel point in the scene depth image is within a preset value interval.

Specifically, the relative depth relationship of each scene subject can be determined by the mutual occlusion relationship between multiple scene subjects contained in the to-be-processed scene image, and the relative depth relationship can be taken as the comparison result. Further, based on the relative depth relationship of each scene subject, the depth value of the image pixel points corresponding to each scene subject is assigned, so as to generate a binary depth map, typically, a black-and-white map. Then, the depth value corresponding to the binary depth map can be mapped into a numerical value between 0 and 1 based on the preset nonlinear conversion algorithm and the relative depth relationship, so as to obtain a grayscale depth map; and the grayscale depth map can be taken as the scene depth image corresponding to the to-be-processed scene image. The nonlinear conversion algorithm can be set according to actual situations, and there is no restriction on which kind of nonlinear conversion algorithm is adopted here, and the algorithms that can convert binary images into grayscale images are all within the protection scope of the embodiment of the present disclosure.

In practical applications, the resolution of scene depth images obtained by different obtaining methods also varies. Directly using depth values from a low-resolution scene depth image for effect processing may affect the display effect of the effect scene image. Optionally, after obtaining the scene depth image corresponding to to-be-processed scene image, the method further includes: performing Gaussian blur processing on the scene depth image, and updating the scene depth image based on a processing result. The technical solution is especially suitable for the scene depth image with relatively low resolution, so the scene depth image can be subjected to Gaussian blur processing in the case where the resolution of the to-be-processed scene image does not reach a preset high-resolution threshold. Gaussian blur processing can reduce the occurrence of jagged information caused by low resolution of the scene depth image, thereby ensuring the rendering effect of the liquid effect object in the effect scene image.

S350: Generating the effect scene image based on the object region effect and the scene display region, and displaying the effect scene image.

S360: Adjusting, in response to a liquid level adjustment trigger operation for the liquid effect object, the display liquid level of the liquid effect object, and updating the effect scene image based on the adjusted display liquid level.

According to the technical solution of the embodiment of the present disclosure, in the case where the object effect rendering region includes the first rendering region, caustics color information and basic color information corresponding to the liquid effect object are determined, and an object region effect corresponding to the first rendering region of the liquid effect object is determined based on the basic color information and the caustics color information. Compared with the method of directly obtaining the basic color information corresponding to the liquid effect object, the caustics color information is added, so that the variation of the liquid effect object can be more diverse, with a sparkling visual effect, and further, the flexibility of the liquid effect object is improved and the user's effect processing experience is improved.

FIG. 4 is a flowchart of another effect processing method provided by an embodiment of the present disclosure. On the basis of the above embodiment, the technical solution of the present embodiment further refines how to render the effect at the liquid surface region of the liquid effect object. Optionally, in the case where the object effect rendering region includes the first rendering region and the second rendering region, a regional boundary between the first rendering region and the second rendering region is determined, and a transitional rendering region in the second rendering region is determined based on the regional boundary, wherein the first rendering region corresponds to the scene display region; for each to-be-rendered pixel point in the transitional rendering region, a reference pixel point corresponding to the to-be-rendered pixel point is determined based on the regional boundary, and target color information corresponding to the to-be-rendered pixel point is determined based on a first depth value corresponding to the to-be-rendered pixel point and a second depth value corresponding to the reference pixel point; an object region effect of the transitional rendering region is obtained based on the target color information corresponding to each to-be-rendered pixel point in the transitional rendering region. The specific implementation method can be found in the description of the present embodiment. The technical features that are the same or similar to the aforementioned embodiments will not be repeated here.

As shown in FIG. 4, the method of the present embodiment can specifically include:

S410: Obtaining, in response to an effect trigger operation, a liquid effect object and a to-be-processed scene image corresponding to the effect trigger operation.

S420: Determining, based on the display liquid level of the liquid effect object, an object effect rendering region corresponding to the liquid effect object and a scene display region corresponding to the to-be-processed scene image, wherein the object effect rendering region includes a first rendering region below a liquid surface of the liquid effect object and a second rendering region corresponding to the liquid surface.

S430: Determining, if the object effect rendering region includes the first rendering region and the second rendering region, a regional boundary between the first rendering region and the second rendering region, and determining a transitional rendering region in the second rendering region based on the regional boundary.

The first rendering region corresponds to the scene display region. In other words, in the present technical solution, the to-be-processed scene image can be rendered into the first rendering region. The transitional rendering region can be a region adjacent to the regional boundary in the second rendering region. The transitional rendering region is used to weaken the display information of the regional boundary, thus realizing the smooth transition from the second rendering region to the first rendering region. Specifically, a three-dimensional object model of the liquid effect object can be obtained, and the regional boundary between the first rendering region and the second rendering region can be determined based on the three-dimensional object model and the display liquid level of the liquid effect object. It should be noted that the regional sizes of the first rendering region, the second rendering region and the transitional rendering region can be set according to actual needs, and are not specifically limited here.

S440: Determining, for each to-be-rendered pixel point in the transitional rendering region, a reference pixel point corresponding to the to-be-rendered pixel point based on the regional boundary, and determining target color information corresponding to the to-be-rendered pixel point based on a first depth value corresponding to the to-be-rendered pixel point and a second depth value corresponding to the reference pixel point.

The reference pixel point can be understood as a pixel point whose depth value is to be compared with that of the to-be-rendered pixel point, which can be used to determine which color to use for the to-be-rendered pixel point. Optionally, the reference pixel point can be a point on the regional boundary or a point adjacent to the regional boundary. Illustratively, a straight line can be drawn along a direction perpendicular to the horizontal plane through the to-be-rendered pixel point, and the intersection point of the straight line and the regional boundary can be taken as the reference pixel point corresponding to the to-be-rendered pixel point. Or, a perpendicular line is drawn to the regional boundary through the to-be-rendered pixel point, and the intersection point of the perpendicular line and the regional boundary is taken as the reference pixel point corresponding to the to-be-rendered pixel point.

Before determining target color information corresponding to the to-be-rendered pixel point based on a first depth value corresponding to the to-be-rendered pixel point and a second depth value corresponding to the reference pixel point, the first depth value corresponding to the to-be-rendered pixel point and the second depth value corresponding to the reference pixel point need to be obtained first. Then, the target color information corresponding to the to-be-rendered pixel point is determined based on the first depth value and the second depth value.

Optionally, obtaining the first depth value corresponding to the to-be-rendered pixel point includes: obtaining an object three-dimensional model corresponding to the liquid effect object, and determining the first depth value corresponding to the to-be-rendered pixel point based on model coordinates of the to-be-rendered pixel point in the object three-dimensional model. Specifically, a coordinate value in a preset direction (e.g., Z direction) among the model coordinates of the to-be-rendered pixel point of the object three-dimensional model in the local spatial coordinate system can be obtained as the first depth value corresponding to the to-be-rendered pixel point. By adopting the present technical solution, the first depth value corresponding to the to-be-rendered pixel point can be conveniently and quickly determined, and the rendering position of each to-be-rendered pixel point can be fully guaranteed through the object three-dimensional model, thus ensuring the rendering effect.

Optionally, obtaining the second depth value corresponding to the reference pixel point includes: obtaining a scene depth image corresponding to the to-be-processed scene image, and determining the second depth value corresponding to the reference pixel point based on the scene depth image. The scene depth image can be understood as an image used to indicate a depth value corresponding to each pixel point in the to-be-processed scene image. Specifically, the pixel point coordinates of the reference pixel point in the to-be-processed scene image can be determined first, and then the depth value corresponding to the pixel point coordinates in the scene depth image can be determined, and the depth value can be taken as the second depth value corresponding to the reference pixel point. By adopting the technical solution, depth values can be assigned to the to-be-processed scene image, so that it has depth information; and the depth information of the reference pixel point can be obtained in this way as the reference depth value of the to-be-rendered pixel point, which lays a foundation for the high adaptability between the rendering effect of the liquid effect object and the to-be-processed scene image.

Specifically, determining the object region effect of the transitional rendering region based on the first depth value and the second depth value can include: determining a depth difference between the first depth value and the second depth value; obtaining basic color information corresponding to the liquid effect object, and adjusting the basic color information based on the depth difference, so as to obtain target color information corresponding to the to-be-rendered pixel point.

The depth difference can be a difference obtained by subtracting the first depth value from the second depth value, and can also be an absolute value of the difference between the first depth value and the second depth value. Optionally, the correlation relationship between the depth difference and the basic color information variation is set in advance. For example, it can be that the greater the depth difference, the greater the color value corresponding to the basic color information, that is, the greater the difference between the depth differences, the darker the color of the liquid effect object, and conversely, the smaller the difference between the depth differences, the lighter the color of the liquid effect object. In other words, in the effect scene image, the greater the difference between the second depth of the to-be-processed scene image and the depth of the liquid effect object in the Z-axis direction, the larger the proportion of the basic color information of the liquid effect object, and the smaller the proportion of the color of the to-be-processed scene image. Conversely, at a position with a smaller depth difference, that is, the position close to the scene object in the to-be-processed scene image, the proportion of the basic color information of the liquid effect object is smaller, and the proportion of the color of the to-be-processed scene image is larger. The advantage of processing the to-be-rendered pixel points in the transitional rendering region by adopting the present technical solution is that the region of the liquid surface of the liquid effect object adjacent to the to-be-processed scene image can be gradually transitioned to the color of the to-be-processed scene image itself.

For example, the correlation relationship between the depth difference and the basic color information variation can be a correspondence relationship between the depth difference or the depth difference range and the variation amount of the basic color information. For example, in the case where the depth difference is A, the target color information corresponding to the to-be-rendered pixel point is obtained by adding B % to the basic color information.

In order to ensure the overall rendering effect of the first rendering region, the variation interval of the variation amount of the basic color information can be set; for example, the color value corresponding to the liquid effect object at the boundary of the transitional rendering region can be taken as an endpoint value of the variation interval of the variation amount of the basic color information.

S450: Obtaining an object region effect of the transitional rendering region based on the target color information corresponding to each to-be-rendered pixel point in the transitional rendering region, generating the effect scene image based on the object region effect and the scene display region, and displaying the effect scene image.

In the case where the to-be-rendered pixel points include each pixel point in the transitional rendering region, the target color information corresponding to each to-be-rendered pixel point can be written into the transitional rendering region, so as to obtain the object region effect of the transitional rendering region.

In the case where the to-be-rendered pixel points include part of the pixel points in the transitional rendering region, the target color information of the remaining pixel points in the transitional rendering region is determined according to the target color information corresponding to the to-be-rendered pixel points, and then the target color information corresponding to all of the pixel points is written into the transitional rendering region, so as to obtain the object region effect of the transitional rendering region. Optionally, according to the target color information corresponding to the to-be-rendered pixel points, the target color information of the remaining pixel points in the transitional rendering region is determined by linear or nonlinear interpolation.

S460: Adjusting, in response to a liquid level adjustment trigger operation for the liquid effect object, the display liquid level of the liquid effect object, and updating the effect scene image based on the adjusted display liquid level.

According to the technical solution of the embodiment of the present disclosure, in the case where the object effect rendering region includes the first rendering region and the second rendering region, the regional boundary between the first rendering region and the second rendering region is determined, and then the transitional rendering region in the second rendering region is determined based on the regional boundary, so that sufficient attention is paid to the rendering at the regional boundary. Furthermore, for each to-be-rendered pixel point in the transitional rendering region, a reference pixel point corresponding to the to-be-rendered pixel point is determined based on the regional boundary, target color information corresponding to the to-be-rendered pixel point is determined based on a first depth value corresponding to the to-be-rendered pixel point and a second depth value corresponding to the reference pixel point, and the to-be-rendered pixel points in the transitional rendering region are adjusted one by one, thus realizing the fine processing of the transitional rendering region. Finally, an object region effect of the transitional rendering region is obtained based on the target color information corresponding to each to-be-rendered pixel point in the transitional rendering region. The pixel-level targeted processing of the transitional rendering region is achieved through the depth information system of the pixel points, so that the gradual change between the second rendering region and the first rendering region is fully guaranteed, the regional boundary is weakened, the borderless connection between the second rendering region and the first rendering region in the effect processing image in the visual effect is improved, and the display effect of the effect scene image is improved.

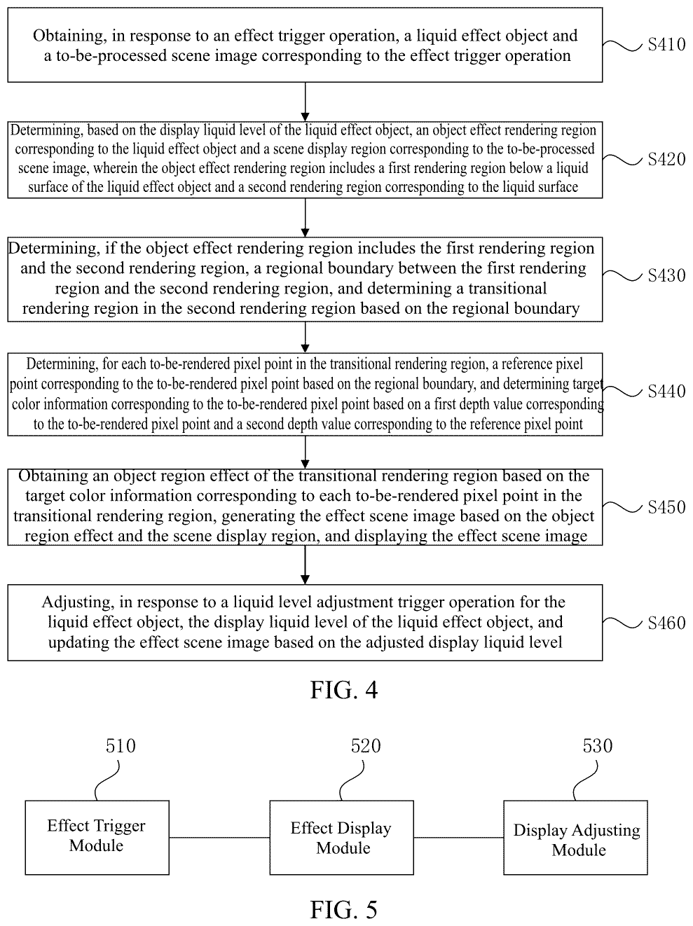

FIG. 5 is a schematic structural diagram of an effect processing apparatus provided by an embodiment of the present disclosure. As illustrated in FIG. 5, the apparatus includes an effect trigger module 510, an effect display module 520 and a display adjusting module 530. The effect trigger module 510 is configured to obtain, in response to an effect trigger operation, a liquid effect object and a to-be-processed scene image corresponding to the effect trigger operation; the effect display module 520 is configured to generate an effect scene image based on the liquid effect object and the to-be-processed scene image, and to display the effect scene image; and the display adjusting module 530 is configured to adjust, if a preset liquid level adjustment condition is detected to be achieved, a display liquid level of the liquid effect object, and update the effect scene image based on the adjusted display liquid level.

According to the technical solution of the embodiment of the present disclosure, in response to an effect trigger operation, a liquid effect object and a to-be-processed scene image corresponding to the effect trigger operation are obtained, an effect scene image based on the liquid effect object and the to-be-processed scene image is generated, and the effect scene image is displayed, so that the user's effect processing intention can be accurately captured based on the effect trigger operation, and the effect image corresponding to the user's effect processing intention can be automatically generated and displayed, facilitating the user viewing the effect. Further, in response to a liquid level adjustment trigger operation for the liquid effect object, the display liquid level of the liquid effect object is adjusted, and the effect scene image is updated based on the adjusted display liquid level, so that the display mode of the effect scene image can be adjusted based on the user's interactive operation, the technical problems that the display effect of the effect image is relatively simple and lacks interaction with the user are solved; adjusting the display liquid level of the liquid effect object through interactive operation is supported, and the display liquid level is associated with the display effect of the effect scene image, thus enriching the effect of the liquid effect object and the to-be-processed scene image, realizing the flexible adjustment of the effect, increasing the interest of effect processing, and improving the effect processing experience of the user.

On the basis of any technical solution of the embodiment of the present disclosure, optionally, the effect display module can be configured to perform at least one of the following operations:
receiving a control trigger operation that acts on a preset display liquid level adjustment control;
receiving a liquid level adjustment trigger operation that acts on the liquid effect object displayed in the effect scene image;
receiving a terminal posture adjustment operation of an effect processing terminal corresponding to the effect trigger operation;
detecting that a liquid level adjustment time of the display liquid level corresponding to the liquid effect object is reached;
detecting an audio control instruction and/or a gesture control instruction for adjusting the display liquid level corresponding to the liquid effect object.

On the basis of any technical solution of the embodiment of the present disclosure, optionally, the effect processing apparatus further includes: a color adjusting module, configured to adjust, after the display liquid level of the liquid effect object is adjusted, display color information of the liquid effect object based on the display liquid level.

On the basis of any technical solution of the embodiment of the present disclosure, optionally, the effect processing apparatus further includes: a status switching module, configured to switch, after the display liquid level of the liquid effect object is adjusted and if the display liquid level reaches a preset status switching height threshold, a relative display status between the to-be-processed scene image and the liquid effect object, wherein the relative display status at least includes a first display state in which at least part of the to-be-processed scene image is displayed above a liquid surface of the liquid effect object and a second display state in which at least part of the to-be-processed scene image is displayed below the liquid surface of the liquid effect object.

On the basis of any technical solution of the embodiment of the present disclosure, optionally, the effect display module includes a region determining unit and an effect generating unit. The region determining unit is configured to determine, based on the display liquid level of the liquid effect object, an object effect rendering region corresponding to the liquid effect object and a scene display region corresponding to the to-be-processed scene image, wherein the object effect rendering region includes a first rendering region below a liquid surface of the liquid effect object and/or a second rendering region corresponding to the liquid surface; and the effect generating unit is configured to determine an object region effect based on the object effect rendering region, and generate the effect scene image based on the object region effect and the scene display region.

On the basis of any technical solution of the embodiment of the present disclosure, optionally, the effect generating unit includes an object color determining sub-unit and a region effect determining sub-unit. The object color determining sub-unit is configured to determine, if the object effect rendering region includes the first rendering region, caustics color information and basic color information corresponding to the liquid effect object; and the region effect determining sub-unit is configured to determine an object region effect corresponding to the first rendering region of the liquid effect object based on the basic color information and the caustics color information.

On the basis of any technical solution of the embodiment of the present disclosure, optionally, the object color determining sub-unit is configured to: obtain a preset basic color information corresponding to the liquid effect object; or, determine the basic color information corresponding to the liquid effect object according to a first included angle between a viewing angle and a normal of the liquid surface of the liquid effect object and a second included angle between the viewing angle and an orientation of parallel light.

On the basis of any technical solution of the embodiment of the present disclosure, optionally, the object color determining sub-unit is configured to: determine first caustics sampling coordinates and second caustics sampling coordinates; sample a preset caustics map based on the first caustics sampling coordinates and the second caustics sampling coordinates, respectively, so as to obtain a first sampling caustics value and a second sampling caustics value; determine the caustics color information corresponding to the liquid effect object based on the first sampling caustics value and the second sampling caustics value.

On the basis of any technical solution of the embodiment of the present disclosure, optionally, the object color determining sub-unit can be specifically configured to: obtain, for each to-be-rendered pixel point in the first rendering region, first reference sampling coordinates and second reference sampling coordinates, and determine sampling disturbance information corresponding to the first reference sampling coordinates and the second reference sampling coordinates, respectively; determine the first caustics sampling coordinates and the second caustics sampling coordinates, respectively, based on the first reference sampling coordinates, the second reference sampling coordinates and the sampling disturbance information.

On the basis of any technical solution of the embodiment of the present disclosure, optionally, the object color determining sub-unit is further configured to: determine a projection point of the to-be-rendered pixel point on the liquid surface of the liquid effect object; determine a normal corresponding to the projection point based on a preset normal map, and determine, based on the normal, the sampling disturbance information corresponding to the first reference sampling coordinates and the second reference sampling coordinates, respectively.

On the basis of any technical solution of the embodiment of the present disclosure, optionally, the region effect determining sub-unit includes a scene depth obtaining block and a color mixing block. The scene depth obtaining block is configured to obtain a scene depth image corresponding to the to-be-processed scene image; and the color mixing block is configured to mix the basic color information and the caustics color information based on the scene depth image, so as to obtain the object region effect corresponding to the first rendering region of the liquid effect object.

On the basis of any technical solution of the embodiment of the present disclosure, optionally, the effect generating unit includes a transitional region determining unit, a pixel color determining unit and a region effect generating unit.

The transitional region determining unit is configured to determine, if the object effect rendering region includes the first rendering region and the second rendering region, a regional boundary between the first rendering region and the second rendering region, and determine a transitional rendering region in the second rendering region based on the regional boundary, wherein the first rendering region corresponds to the scene display region; the pixel color determining unit is configured to determine, for each to-be-rendered pixel point in the transitional rendering region, a reference pixel point corresponding to the to-be-rendered pixel point based on the regional boundary, and determine target color information corresponding to the to-be-rendered pixel point based on a first depth value corresponding to the to-be-rendered pixel point and a second depth value corresponding to the reference pixel point; and the region effect generating unit is configured to obtain an object region effect of the transitional rendering region based on the target color information corresponding to each to-be-rendered pixel point in the transitional rendering region.

On the basis of any technical solution of the embodiment of the present disclosure, optionally, the pixel color determining unit includes a first depth determining sub-unit, a second depth determining sub-unit and a color information determining sub-unit, and the second depth determining sub-unit includes a scene depth obtaining block and a second depth value determining block.

The first depth determining sub-unit is configured to obtain an object three-dimensional model corresponding to the liquid effect object, and determine the first depth value corresponding to the to-be-rendered pixel point based on model coordinates of the to-be-rendered pixel point in the object three-dimensional model; the scene depth obtaining block is configured to obtain a scene depth image corresponding to the to-be-processed scene image; the second depth value determining block is configured to determine the second depth value corresponding to the reference pixel point based on the scene depth image; the color information determining sub-unit is configured to determine the target color information corresponding to the to-be-rendered pixel point based on the first depth value and the second depth value.

On the basis of any technical solution of the embodiment of the present disclosure, optionally, the color information determining sub-unit is configured to: determine a depth difference between the first depth value and the second depth value; obtain basic color information corresponding to the liquid effect object, and adjust the basic color information based on the depth difference, so as to obtain target color information corresponding to the to-be-rendered pixel point.

On the basis of any technical solution of the embodiment of the present disclosure, optionally, the scene depth obtaining block is configured to: acquire the scene depth image corresponding to the to-be-processed scene image based on a depth image acquisition device arranged in a shooting terminal for capturing the to-be-processed scene image; or generating the scene depth image corresponding to the to-be-processed scene image based on the to-be-processed scene image.

On the basis of any technical solution of the embodiment of the present disclosure, optionally, the scene depth obtaining block is specifically configured to: perform a depth comparison on scene subjects contained in the to-be-processed scene image, and generate a binary depth map based on a comparison result; convert the binary depth map into a grayscale depth map based on a preset nonlinear conversion algorithm, and determine the scene depth image corresponding to the to-be-processed scene image based on the grayscale depth map, wherein a depth value corresponding to each pixel point in the scene depth image is within a preset value interval.

On the basis of any technical solution of the embodiment of the present disclosure, optionally, the effect processing apparatus further includes: a depth image processing module, configured to perform, after the scene depth image corresponding to to-be-processed scene image is obtained, Gaussian blur processing on the scene depth image, and update the scene depth image based on a processing result.

The effect processing apparatus provided by the embodiment of the present disclosure can execute the effect processing method provided by any embodiment of the present disclosure, and has corresponding functional modules for executing the method and beneficial effects of the method.

It is worth noting that various units and modules included in the above apparatus is only divided according to functional logic, but are not limited to the above division, as long as the corresponding functions can be realized; in addition, the specific names of various functional units are only for the purpose of distinguishing them from each other, and are not used to limit the protection scope of the embodiment of the present disclosure.

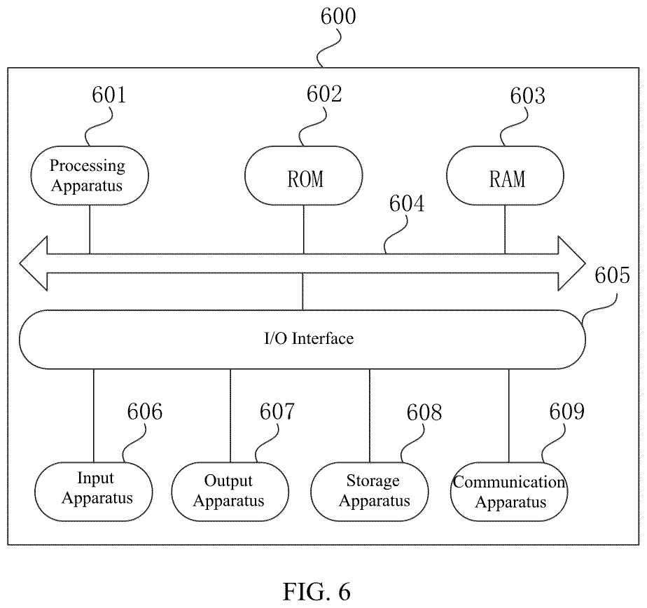

FIG. 6 is a schematic structural diagram of an electronic device provided by an embodiment of the present disclosure. FIG. 6 is specifically referred below, and it shows the structure schematic diagram suitable for achieving the electronic device 600 in the embodiment of the present disclosure. The electronic device 600 in the embodiment of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 6 is only an example and should not impose any limitations on the functions and use scopes of the embodiments of the present disclosure.

As shown in FIG. 6, the electronic device 600 may include a processing apparatus (such as a central processing unit, and a graphics processor) 601, it may execute various appropriate actions and processes according to a program stored in a read-only memory (ROM) 602 or a program loaded from a storage apparatus 608 to a random access memory (RAM) 603. In RAM 603, various programs and data required for operations of the electronic device 600 are also stored. The processing apparatus 601, ROM 602, and RAM 603 are connected to each other by a bus 604. An input/output (I/O) interface 605 is also connected to the bus 604.

Typically, the following apparatuses may be connected to the I/O interface 605: an input apparatus 606 such as a touch screen, a touchpad, a keyboard, a mouse, a camera, a microphone, an accelerometer, and a gyroscope; an output apparatus 607 such as a liquid crystal display (LCD), a loudspeaker, and a vibrator; a storage apparatus 608 such as a magnetic tape, and a hard disk drive; and a communication apparatus 609. The communication apparatus 609 may allow the electronic device 600 to wireless-communicate or wire-communicate with other devices so as to exchange data. Although FIG. 6 shows the electronic device 600 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 609, or installed from the storage apparatus 608, or installed from ROM 602. When the computer program is executed by the processing apparatus 601, the above functions defined in the embodiments of the present disclosure are executed.

The names of messages or information exchanged between multiple apparatuses in the embodiments of the present disclosure are used for illustrative purposes only, and are not used to limit the scope of these messages or information.

The electronic device provided by the embodiment of the present disclosure belongs to the same inventive concept as the effect processing method provided by the above embodiment, and the technical details not fully described in the present embodiment can be found in the above embodiment, and the present embodiment has the same beneficial effects as the above embodiment.

An embodiment of the present disclosure provides a computer storage medium on which a computer program is stored, and the computer program, when executed by a processor, realizes the effect processing method provided by the above embodiment.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The computer-readable medium may be included in the electronic device; Or it can exist alone without being assembled into the electronic equipment.

The computer-readable medium carries one or more programs, and the one or more programs, when executed by the electronic device, cause the electronic device to: obtain, in response to an effect trigger operation, a liquid effect object and a to-be-processed scene image corresponding to the effect trigger operation; generate an effect scene image based on the liquid effect object and the to-be-processed scene image, and display the effect scene image; adjust, if a preset liquid level adjustment condition is detected to be achieved, a display liquid level of the liquid effect object, and update the effect scene image based on the adjusted display liquid level.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases. For example, the first obtaining unit can also be described as “a unit that obtains at least two Internet protocol addresses”.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, Example 1 provides an effect processing method, which includes: obtaining, in response to an effect trigger operation, a liquid effect object and a to-be-processed scene image corresponding to the effect trigger operation; generating an effect scene image based on the liquid effect object and the to-be-processed scene image, and displaying the effect scene image; adjusting, if a preset liquid level adjustment condition is detected to be achieved, a display liquid level of the liquid effect object, and updating the effect scene image based on the adjusted display liquid level.

According to one or more embodiments of the present disclosure, Example 2 provides the method of Example 1, and further includes: optionally, the liquid level adjustment condition includes at least one of the following conditions: receiving a control trigger operation that acts on a preset display liquid level adjustment control; receiving a liquid level adjustment trigger operation that acts on the liquid effect object displayed in the effect scene image; receiving a terminal posture adjustment operation of an effect processing terminal corresponding to the effect trigger operation; detecting that a liquid level adjustment time of the display liquid level corresponding to the liquid effect object is reached; detecting an audio control instruction and/or a gesture control instruction for adjusting the display liquid level corresponding to the liquid effect object.

According to one or more embodiments of the present disclosure, Example 3 provides the method of Example 1, and further includes: optionally, after adjusting the display liquid level of the liquid effect object, the method further includes: adjusting display color information of the liquid effect object based on the display liquid level.

According to one or more embodiments of the present disclosure, Example 4 provides the method of Example 1, and further includes: optionally, after adjusting the display liquid level of the liquid effect object, the method further includes: switching, if the display liquid level reaches a preset status switching height threshold, a relative display status between the to-be-processed scene image and the liquid effect object, wherein the relative display status at least includes a first display state in which at least part of the to-be-processed scene image is displayed above a liquid surface of the liquid effect object and a second display state in which at least part of the to-be-processed scene image is displayed below the liquid surface of the liquid effect object.

According to one or more embodiments of the present disclosure, Example 5 provides the method of Example 1, and further includes: optionally, the generating an effect scene image based on the liquid effect object and the to-be-processed scene image includes: determining, based on the display liquid level of the liquid effect object, an object effect rendering region corresponding to the liquid effect object and a scene display region corresponding to the to-be-processed scene image, wherein the object effect rendering region includes a first rendering region below a liquid surface of the liquid effect object and/or a second rendering region corresponding to the liquid surface; determining an object region effect based on the object effect rendering region, and generating the effect scene image based on the object region effect and the scene display region.

According to one or more embodiments of the present disclosure, Example 6 provides the method of Example 5, and further includes: optionally, the determining an object region effect based on the object effect rendering region includes: determining, if the object effect rendering region includes the first rendering region, caustics color information and basic color information corresponding to the liquid effect object; determining an object region effect corresponding to the first rendering region of the liquid effect object based on the basic color information and the caustics color information.

According to one or more embodiments of the present disclosure, Example 7 provides the method of Example 6, and further includes: optionally, the determining the basic color information corresponding to the liquid effect object includes: obtaining a preset basic color information corresponding to the liquid effect object; or, determining the basic color information corresponding to the liquid effect object according to a first included angle between a viewing angle and a normal of the liquid surface of the liquid effect object and a second included angle between the viewing angle and an orientation of parallel light.

According to one or more embodiments of the present disclosure, Example 8 provides the method of Example 6, and further includes: optionally, the determining caustics color information corresponding to the liquid effect object includes: determining first caustics sampling coordinates and second caustics sampling coordinates; sampling a preset caustics map based on the first caustics sampling coordinates and the second caustics sampling coordinates, respectively, so as to obtain a first sampling caustics value and a second sampling caustics value; determining the caustics color information corresponding to the liquid effect object based on the first sampling caustics value and the second sampling caustics value.

According to one or more embodiments of the present disclosure, Example 9 provides the method of Example 8, and further includes: optionally, the determining first caustics sampling coordinates and second caustics sampling coordinates includes: obtaining, for each to-be-rendered pixel point in the first rendering region, first reference sampling coordinates and second reference sampling coordinates, and determining sampling disturbance information corresponding to the first reference sampling coordinates and the second reference sampling coordinates, respectively; determining the first caustics sampling coordinates and the second caustics sampling coordinates, respectively, based on the first reference sampling coordinates, the second reference sampling coordinates and the sampling disturbance information.

According to one or more embodiments of the present disclosure, Example 10 provides the method of Example 9, and further includes: optionally, the determining sampling disturbance information corresponding to the first reference sampling coordinates and the second reference sampling coordinates, respectively, includes: determining a projection point of the to-be-rendered pixel point on the liquid surface of the liquid effect object; determining a normal corresponding to the projection point based on a preset normal map, and determining, based on the normal, the sampling disturbance information corresponding to the first reference sampling coordinates and the second reference sampling coordinates, respectively.

According to one or more embodiments of the present disclosure, Example 11 provides the method of Example 6, and further includes: optionally, the determining an object region effect corresponding to the first rendering region of the liquid effect object based on the basic color information and the caustics color information includes: obtaining a scene depth image corresponding to the to-be-processed scene image, and mixing the basic color information and the caustics color information based on the scene depth image, so as to obtain the object region effect corresponding to the first rendering region of the liquid effect object.

According to one or more embodiments of the present disclosure, Example 12 provides the method of Example 5, and further includes: optionally, the determining an object region effect based on the object effect rendering region includes: determining, if the object effect rendering region includes the first rendering region and the second rendering region, a regional boundary between the first rendering region and the second rendering region, and determining a transitional rendering region in the second rendering region based on the regional boundary, wherein the first rendering region corresponds to the scene display region; determining, for each to-be-rendered pixel point in the transitional rendering region, a reference pixel point corresponding to the to-be-rendered pixel point based on the regional boundary, and determining target color information corresponding to the to-be-rendered pixel point based on a first depth value corresponding to the to-be-rendered pixel point and a second depth value corresponding to the reference pixel point; obtaining an object region effect of the transitional rendering region based on the target color information corresponding to each to-be-rendered pixel point in the transitional rendering region.

According to one or more embodiments of the present disclosure, Example 13 provides the method of Example 12, and further includes: optionally, the determining target color information corresponding to the to-be-rendered pixel point based on a first depth value corresponding to the to-be-rendered pixel point and a second depth value corresponding to the reference pixel point includes: obtaining an object three-dimensional model corresponding to the liquid effect object, and determining the first depth value corresponding to the to-be-rendered pixel point based on model coordinates of the to-be-rendered pixel point in the object three-dimensional model; obtaining a scene depth image corresponding to the to-be-processed scene image, and determining the second depth value corresponding to the reference pixel point based on the scene depth image; determining the target color information corresponding to the to-be-rendered pixel point based on the first depth value and the second depth value.

According to one or more embodiments of the present disclosure, Example 14 provides the method of Example 13, and further includes: optionally, the determining an object region effect of the transitional rendering region based on the first depth value and the second depth value includes: determining a depth difference between the first depth value and the second depth value; obtaining basic color information corresponding to the liquid effect object, and adjusting the basic color information based on the depth difference, so as to obtain target color information corresponding to the to-be-rendered pixel point.

According to one or more embodiments of the present disclosure, Example 15 provides the method of Example 11 or Example 13, and further includes: optionally, the obtaining a scene depth image corresponding to the to-be-processed scene image includes: acquiring the scene depth image corresponding to the to-be-processed scene image based on a depth image acquisition device arranged in a shooting terminal for capturing the to-be-processed scene image; or, generating the scene depth image corresponding to the to-be-processed scene image based on the to-be-processed scene image.

According to one or more embodiments of the present disclosure, Example 16 provides the method of Example 15, and further includes: optionally, the generating the scene depth image corresponding to the to-be-processed scene image based on the to-be-processed scene image includes: performing a depth comparison on scene subjects contained in the to-be-processed scene image, and generating a binary depth map based on a comparison result; converting the binary depth map into a grayscale depth map based on a preset nonlinear conversion algorithm, and determining the scene depth image corresponding to the to-be-processed scene image based on the grayscale depth map, wherein a depth value corresponding to each pixel point in the scene depth image is within a preset value interval.

According to one or more embodiments of the present disclosure, Example 17 provides the method of Example 11 or Example 13, and further includes: optionally, after obtaining the scene depth image corresponding to to-be-processed scene image, the method further includes: performing Gaussian blur processing on the scene depth image, and updating the scene depth image based on a processing result.

According to one or more embodiments of the present disclosure, Example 1 provides an effect processing apparatus, which includes: an effect trigger module, configured to obtain, in response to an effect trigger operation, a liquid effect object and a to-be-processed scene image corresponding to the effect trigger operation; an effect display module, configured to generate an effect scene image based on the liquid effect object and the to-be-processed scene image, and to display the effect scene image; a display adjusting module, configured to adjust, if a preset liquid level adjustment condition is detected to be achieved, a display liquid level of the liquid effect object, and update the effect scene image based on the adjusted display liquid level.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. An effect processing method, comprising:
obtaining, in response to an effect trigger operation, a liquid effect object and a to-be-processed scene image corresponding to the effect trigger operation;
generating an effect scene image based on the liquid effect object and the to-be-processed scene image, and displaying the effect scene image; and
adjusting, if a preset liquid level adjustment condition is detected to be achieved, a display liquid level of the liquid effect object, and updating the effect scene image based on the adjusted display liquid level.

2. The effect processing method according to claim 1, wherein the liquid level adjustment condition comprises at least one of the following conditions:
receiving a control trigger operation that acts on a preset display liquid level adjustment control;
receiving a liquid level adjustment trigger operation that acts on the liquid effect object displayed in the effect scene image;
receiving a terminal posture adjustment operation of an effect processing terminal corresponding to the effect trigger operation;
detecting that a liquid level adjustment time of the display liquid level corresponding to the liquid effect object is reached;
detecting an audio control instruction and/or a gesture control instruction for adjusting the display liquid level corresponding to the liquid effect object.

3. The effect processing method according to claim 1, wherein after adjusting the display liquid level of the liquid effect object, the method further comprises:
adjusting display color information of the liquid effect object based on the display liquid level.

4. The effect processing method according to claim 1, wherein after adjusting the display liquid level of the liquid effect object, the method further comprises:
switching, if the display liquid level reaches a preset status switching height threshold, a relative display status between the to-be-processed scene image and the liquid effect object, wherein the relative display status at least comprises a first display state and a second display state, in the first display state, at least part of the to-be-processed scene image is displayed above a liquid surface of the liquid effect object, and in the second display state, at least part of the to-be-processed scene image is displayed below the liquid surface of the liquid effect object.

5. The effect processing method according to claim 1, wherein the generating an effect scene image based on the liquid effect object and the to-be-processed scene image comprises:
determining, based on the display liquid level of the liquid effect object, an object effect rendering region corresponding to the liquid effect object and a scene display region corresponding to the to-be-processed scene image, wherein the object effect rendering region comprises a first rendering region below a liquid surface of the liquid effect object and/or a second rendering region corresponding to the liquid surface;
determining an object region effect based on the object effect rendering region, and generating the effect scene image based on the object region effect and the scene display region.

6. The effect processing method according to claim 5, wherein the determining an object region effect based on the object effect rendering region comprises:
determining, if the object effect rendering region comprises the first rendering region, caustics color information and basic color information corresponding to the liquid effect object;
determining an object region effect corresponding to the first rendering region of the liquid effect object based on the basic color information and the caustics color information.

7. The effect processing method according to claim 6, wherein the determining caustics color information corresponding to the liquid effect object comprises:
determining first caustics sampling coordinates and second caustics sampling coordinates;
sampling a preset caustics map based on the first caustics sampling coordinates and the second caustics sampling coordinates, respectively, so as to obtain a first sampling caustics value and a second sampling caustics value;
determining the caustics color information corresponding to the liquid effect object based on the first sampling caustics value and the second sampling caustics value.

8. The effect processing method according to claim 7, wherein the determining first caustics sampling coordinates and second caustics sampling coordinates comprises:
obtaining, for each to-be-rendered pixel point in the first rendering region, first reference sampling coordinates and second reference sampling coordinates, and determining sampling disturbance information corresponding to the first reference sampling coordinates and the second reference sampling coordinates, respectively;
determining the first caustics sampling coordinates and the second caustics sampling coordinates, respectively, based on the first reference sampling coordinates, the second reference sampling coordinates and the sampling disturbance information.

9. The effect processing method according to claim 6, wherein the determining an object region effect corresponding to the first rendering region of the liquid effect object based on the basic color information and the caustics color information comprises:
obtaining a scene depth image corresponding to the to-be-processed scene image, and mixing the basic color information and the caustics color information based on the scene depth image, so as to obtain the object region effect corresponding to the first rendering region of the liquid effect object.

10. The effect processing method according to claim 9, wherein the obtaining a scene depth image corresponding to the to-be-processed scene image comprises:
acquiring the scene depth image corresponding to the to-be-processed scene image based on a depth image acquisition device arranged in a shooting terminal for capturing the to-be-processed scene image; or
generating the scene depth image corresponding to the to-be-processed scene image based on the to-be-processed scene image.

11. The effect processing method according to claim 10, wherein the generating the scene depth image corresponding to the to-be-processed scene image based on the to-be-processed scene image comprises:
performing a depth comparison on scene subjects contained in the to-be-processed scene image, and generating a binary depth map based on a comparison result;
converting the binary depth map into a grayscale depth map based on a preset nonlinear conversion algorithm, and determining the scene depth image corresponding to the to-be-processed scene image based on the grayscale depth map, wherein a depth value corresponding to each pixel point in the scene depth image is within a preset value interval.

12. The effect processing method according to claim 5, wherein the determining an object region effect based on the object effect rendering region comprises:
determining, if the object effect rendering region comprises the first rendering region and the second rendering region, a regional boundary between the first rendering region and the second rendering region, and determining a transitional rendering region in the second rendering region based on the regional boundary, wherein the first rendering region corresponds to the scene display region;
determining, for each to-be-rendered pixel point in the transitional rendering region, a reference pixel point corresponding to the to-be-rendered pixel point based on the regional boundary, and determining target color information corresponding to the to-be-rendered pixel point based on a first depth value corresponding to the to-be-rendered pixel point and a second depth value corresponding to the reference pixel point;
obtaining an object region effect of the transitional rendering region based on the target color information corresponding to each to-be-rendered pixel point in the transitional rendering region.

13. An effect processing apparatus, comprising:
an effect trigger module, configured to obtain, in response to an effect trigger operation, a liquid effect object and a to-be-processed scene image corresponding to the effect trigger operation;
an effect display module, configured to generate an effect scene image based on the liquid effect object and the to-be-processed scene image, and to display the effect scene image;
a display adjusting module, configured to adjust, if a preset liquid level adjustment condition is detected to be achieved, a display liquid level of the liquid effect object, and update the effect scene image based on the adjusted display liquid level.

14. An electronic device, comprising:
one or a plurality of processors;
a storage apparatus, configured to store one or a plurality of programs,
wherein the one or the plurality of programs, when executed by the one or the plurality of processors, cause the one or more the plurality of processors to realize an effect processing method, which comprises:
obtaining, in response to an effect trigger operation, a liquid effect object and a to-be-processed scene image corresponding to the effect trigger operation;
generating an effect scene image based on the liquid effect object and the to-be-processed scene image, and displaying the effect scene image; and
adjusting, if a preset liquid level adjustment condition is detected to be achieved, a display liquid level of the liquid effect object, and updating the effect scene image based on the adjusted display liquid level.

15. The electronic device according to claim 14, wherein the liquid level adjustment condition comprises at least one of the following conditions:
receiving a control trigger operation that acts on a preset display liquid level adjustment control;
receiving a liquid level adjustment trigger operation that acts on the liquid effect object displayed in the effect scene image;
receiving a terminal posture adjustment operation of an effect processing terminal corresponding to the effect trigger operation;
detecting that a liquid level adjustment time of the display liquid level corresponding to the liquid effect object is reached;
detecting an audio control instruction and/or a gesture control instruction for adjusting the display liquid level corresponding to the liquid effect object.

16. The electronic device according to claim 14, wherein after adjusting the display liquid level of the liquid effect object, the method further comprises:
adjusting display color information of the liquid effect object based on the display liquid level.

17. The electronic device according to claim 14, wherein after adjusting the display liquid level of the liquid effect object, the method further comprises:
switching, if the display liquid level reaches a preset status switching height threshold, a relative display status between the to-be-processed scene image and the liquid effect object, wherein the relative display status at least comprises a first display state and a second display state, in the first display state, at least part of the to-be-processed scene image is displayed above a liquid surface of the liquid effect object, and in the second display state, at least part of the to-be-processed scene image is displayed below the liquid surface of the liquid effect object.

18. The electronic device according to claim 14, wherein the generating an effect scene image based on the liquid effect object and the to-be-processed scene image comprises:
determining, based on the display liquid level of the liquid effect object, an object effect rendering region corresponding to the liquid effect object and a scene display region corresponding to the to-be-processed scene image, wherein the object effect rendering region comprises a first rendering region below a liquid surface of the liquid effect object and/or a second rendering region corresponding to the liquid surface;
determining an object region effect based on the object effect rendering region, and generating the effect scene image based on the object region effect and the scene display region.

19. The electronic device according to claim 18, wherein the determining an object region effect based on the object effect rendering region comprises:
determining, if the object effect rendering region comprises the first rendering region, caustics color information and basic color information corresponding to the liquid effect object;
determining an object region effect corresponding to the first rendering region of the liquid effect object based on the basic color information and the caustics color information.

20. A storage medium comprising computer-executable instructions, wherein the computer-executable instructions, when executed by a computer processor, are used for executing the effect processing method according to claim 1.
